(19) United States
(12) Patent Application Publication
(10) Pub. No.: US 2010/0300219 A1
(43) Pub. Date: Dec. 2, 2010

(54) Sub-Sampler

(75) Inventor: Inkwon Um, Incheon (KR)

Correspondence Address: THE WEBB LAW FIRM, P.C., 700 KOPPERS BUILDING, 436 SEVENTH AVENUE, PITTSBURGH, PA, 15219, US

(73) Assignee: Korea Institute of Geoscience and Mineral Resources (KIGAM), Daejeon (KR)

(21) Appl. No.: 12/787,160

(22) Filed: May 25, 2010

(30) Foreign Application Priority Data
May 26, 2009 (KR) 10-2009-0045768

(51) Int. Cl. G01N 1/04

(52) U.S. Cl. 73/864.41

(57) ABSTRACT

Provided is a sub-sampler used for taking a sub-sample from a core sample filled in a liner of a corer. The sub-sampler includes agitation preventing walls 100a, 100b and 100c including a top surface 10 having a predetermined length, a side surface 20 extended to be bent in a downward direction from one end of the top surface 10, and a contact surface 30 extended such that one end of the side surface meets the other end of the top surface 10; and a cut piece 200 that allows an arrangement gap between one agitation preventing wall 100a and any other agitation preventing wall 100b to be regular and that is connected to the side surface 20 in order to close one side surface of the arranged agitation preventing walls 100a, 100b and 100c.

### CROSS-REFERENCE TO RELATED APPLICATIONS

This application claims priority under 35 U.S.C. §119 to Korean Patent Application No. 10-2009-0045768, filed on May 26, 2009, in the Korean Intellectual Property Office, the disclosure of which is incorporated herein by reference in its entirety.

### TECHNICAL FIELD

The following disclosure relates to a sub-sampler for taking a sub-sample from a core sample filled in a liner of a corer.

### BACKGROUND

Continuously deposited sedimentary layers are formed on the base of the river, lake or sea, and an inspection of sediment in the sedimentary layers aids to understand an environment for sediment in the corresponding era and thus analogize the history and environment of the earth.

As such, it is important to take the sediment of the continuous sedimentary layers for studying the sedimentary layers, and a corer is generally used to take a sample of the continuous sedimentary layers. The corer is classified into a vibracorer that uses vibration, a free-fall gravity corer that uses free-fall, a piston corer, a box corer and so on.

The vibracorer is mainly used to take the sediment in coast such as a lake, a marshy land and a foreshore. The coring depth is generally about 5 m and it is variable according to particles in the sediment.

The free-fall gravity corer is provided with a weight for applying a predetermined load and thus takes the sediment not using an external power but by a self-load of the weight. However, since the weight should be also pulled up when the sediment is pulled up after the sediment is taken, a large power is needed for the pulling up operation.

The piston corer has a type for taking sedimentary layers having a large depth in a sea floor. It has been reported that the sedimentary layers having the maximum depth of 38 m Marion survey vessel in France were taken.

The box corer is designed to prevent an error resulted from agitation or removal of the upper portion of the sedimentary layers, and is able to take the sedimentary layers having about 50 cm depth.

With reference to FIGS. 1 and 2, the corer is formed in diverse forms according to objectives but the corer generally includes a core barrel 3 at a lower portion thereof. At a side of the lower portion of the core barrel 3, a cutting head 8 formed to be inserted deep into the sedimentary layers, a core liner 4 included inside the core barrel to take the sediment, and a core catcher 9 for preventing loss of the sediment taken by the core liner are formed.

A sub-sample is taken from a core sample of the core sediment taken by the diverse corers after cutting a liner having the core sample in a longitudinal direction. An interval for taking the sub-sample is determined such that variation according to the depth of items to be investigated can be sufficiently recognized.

A conventional method for taking the sub-sample has a limitation that the sediment may be agitated with neighboring sediment. There is also a limitation that a core sample having a high percentage of water content may be agitated with neighboring sediment by collapse of the sediment around the taken sub-sample while the sub-sample is taken. Since the sediment is sequentially layered as time goes on, agitation of the sediment may cause difficulty or uncertainty in analyzing the sediment.

In addition, when a sample is taken in a specific area, it is not possible to efficiently fill in the area. Accordingly, there is a limitation that rest samples are agitated although the sediment around the sub-sample is not collapsed.

### SUMMARY

An embodiment of the present invention is directed to providing a sub-sampler that stably and accurately takes a sub-sample by preventing that the sub-sample is agitated with neighboring sediment while the sub-sample is taken.

In one general aspect, a sub-sampler for assisting in taking of a sub-sample from a core sample by using a liner of a corer, includes: agitation preventing walls 100a, 100b and 100c including a top surface 10 having a predetermined length, a side surface 20 extended to be bent in a downward direction from one end of the top surface 10, and a contact surface 30 extended such that one end of the side surface meets the other end of the top surface 10; and a cut piece 200 that allows an arrangement gap between one agitation preventing wall 100a and any other agitation preventing wall 100b to be regular and that is connected to the side surface 20 in order to close one side surface of the arranged agitation preventing walls 100a, 100b and 100c.

A curvature of the contact surface 30 of the agitation preventing walls 100a, 100b and 100c may be preferably the same as that of the liner such that when the liner is cut in half in a longitudinal direction on the basis of an end portion of the liner, an inner circumferential surface of one side of the cut liner fits into the contact surface 30.

One agitation preventing wall 100a and another agitation preventing wall 100a may be arranged in parallel and a gap between the agitation preventing walls 100a may be 0.5 to 1 cm. A material of the agitation preventing walls 100a, 100b and 100c and the cut piece 200 may be polypropylene (PP) or polyethylene (PE).

The sub-sampler may further includes: an additional insert member 300 having the same shape of a cross section as that of the agitation preventing walls 100a, 100b and 100c to be able to be inserted into a section formed between one agitation preventing wall 100a and one agitation preventing wall 100b. The material of the insert member 300 may be Styrofoam.

Other features and aspects will be apparent from the following detailed description, the drawings, and the claims.

### BRIEF DESCRIPTION OF THE DRAWINGS

FIG. 1 is a conceptual view showing an operation order of a conventional piston corer.

FIG. 2 is a conceptual view showing a lower portion of the conventional piston corer.

FIG. 3 is a conceptual view showing a liner, in which a core sample is taken.

FIG. 4 is a perspective view showing a cut liner, in which the core sample is taken.

FIG. 5 is an exploded perspective view showing a sub-sampler according to an exemplary embodiment.

FIG. 6 is a conceptual view showing the sub-sampler according to an exemplary embodiment.

### DETAILED DESCRIPTION OF MAIN ELEMENTS

top surface: 10 side surface: 20 contact surface: 30 agitation preventing walls: 100a, 100b and 100c cut piece: 200 insert member: 300

### DETAILED DESCRIPTION OF EMBODIMENTS

Hereinafter, exemplary embodiments will be described in detail with reference to the accompanying drawings.

The present invention relates to a sub-sampler for assisting in taking a sub-sample from a taken core sample by using a liner of a corer.

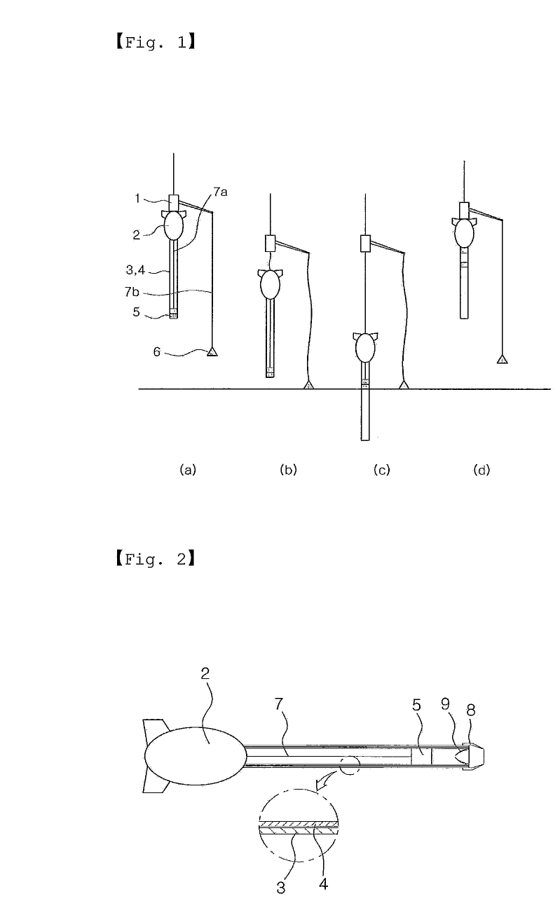

As shown in FIGS. 1 and 2, in order to take a core sample in a liner for coring the core sample, a trigger weight 6 is installed at an end of a cable 7b connected to one end of a release lever arm and drops into the water. When the trigger weight 6 drops on the floor of the water, the release lever arm goes up to an upper portion and is connected to the other end. Subsequently, a corer including a weight 2, a barrel 3, a head 8, a catcher 9, and a liner 4 drops. A piston 5 is called a piston corer when the piston 5 is included inside the liner. The core sample may be taken by drawing a wire 7a, which is connected to the piston 5, in the upper portion. Detailed description on the above operation will not be provided since it is a widely known art.

Components, particle sizes, and a percentage of water content of the sediment are investigated by re-extracting the corer stuck in the sediment of the water and the investigation result is applied as useful data for analyzing changes of an environment for sedimentation.

Due to features of the sea bottom sediment, the sediment is formed of diverse components and particles according to layered times although samples of the sea bottom sediment are taken in the same location. Homogeneity of the taken samples should be maintained during a process of taking, storing and analyzing the sub-sample.

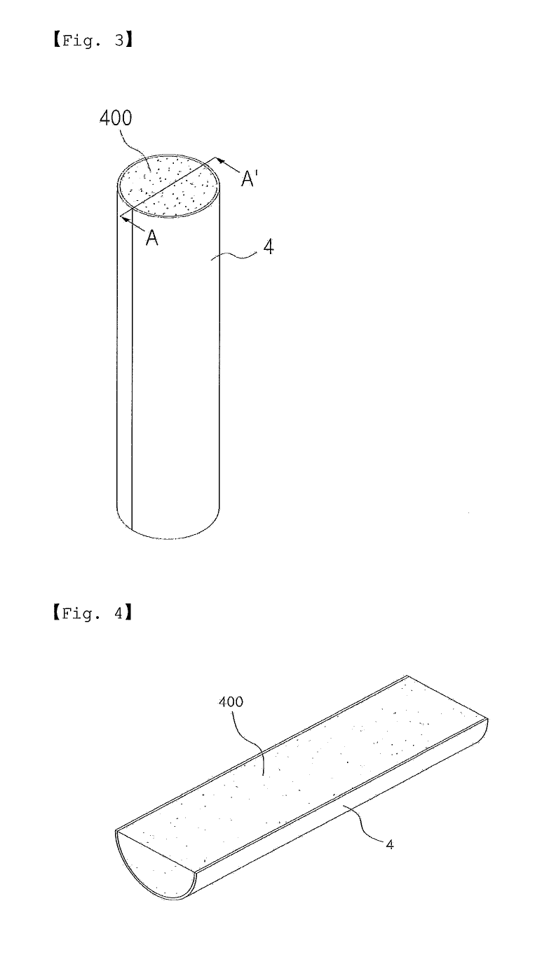

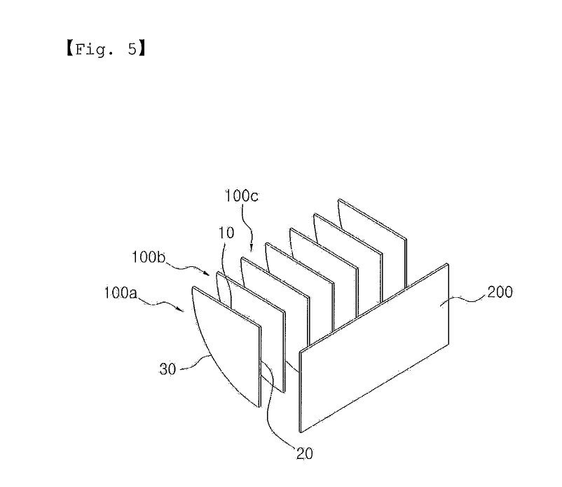

With reference to FIGS. 3 and 4, in order to analyze a core sample 400 cored in the liner 4, a sub-sample is taken with a spoon (see S of FIG. 6) and used in analysis after cutting the liner 4 in half in a longitudinal direction, i.e., an AA′ direction, on the basis of an end surface of the liner 4.

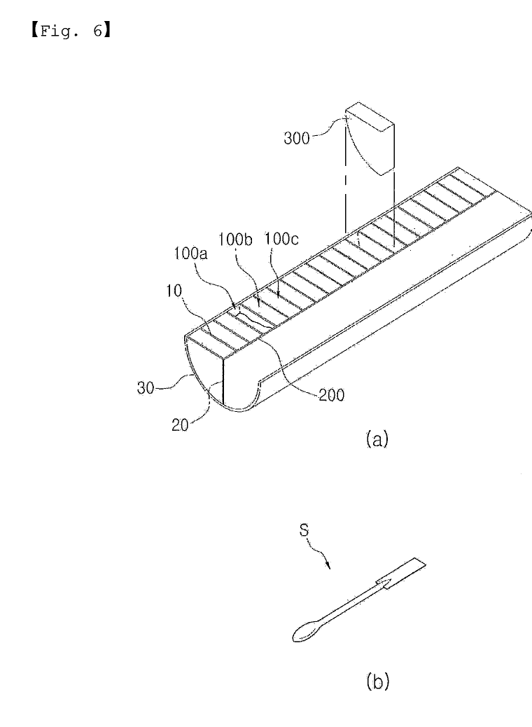

With reference to FIG. 5, the sub-sampler according to the present invention includes a plurality of agitation preventing walls 100a, 100b, and 100c and a cut piece 200 connecting each side of the agitation preventing wall.

The agitation preventing walls 100a, 100b and 100c include a top surface 10 having a predetermined length, a side surface 20 extended to be bent in a downward direction from one end of the top surface 10, and a contact surface 30 extended such that one end of the side surface meets the other end of the top surface 10. An angle between the top surface 10 and the side surface 20 is preferably a right angle.

It is also preferred that a curvature of the contact surface 30 of the agitation preventing walls 100a, 100b and 100c is preferably the same as that of the liner 4 such that when the liner is cut in half in a longitudinal direction on the basis of an end portion of the liner, an inner circumferential surface of one side of the cut liner fits into the contact surface 30. When the inner circumferential surface of one side of the liner 4 contacts the contact surface 30, it is possible to prevent that sub-samples having a high percentage of water content are agitated with each other by unexpected external factors such as an external impact.

In addition, one agitation preventing wall 100a and another agitation preventing wall 100a are arranged in parallel and a gap between the two agitation preventing walls 100a may differ according to objects for investigation but is preferably about 0.5 to 1 cm. It is determined by considering sizes of other samplers as well as a spoon (S) used for taking a general sub-sample.

FIG. 5 shows that the number of the agitation preventing walls is 7 but it is only an example. When a sub-sample having a 0.5-1 cm length is taken from a core sample at a 1 m interval, the number of the required agitation preventing walls is 2 on both sides of left and right. It is also possible to include a plurality of agitation preventing walls at diverse intervals, if necessary.

An arrangement gap between one agitation preventing wall 100a and any other agitation preventing wall 100b is regular in the cut piece 200, which is connected to the side surface 20 in order to close one side surface of the arranged agitation preventing walls 100a, 100b and 100c.

As shown in FIGS. 5 and 6, the cut piece 200 plays a role for comparing the core sample arranged by the agitation preventing walls 100a, 100b and 100c with a non-arranged core sample. It is also easy to store the non-arranged core sample 400 in the cut piece 200.

The agitation preventing walls 100a, 100b and 100c and the cut piece 200 may have a stable material that is washed by acid and does not contaminate the sediment. The material is preferably Teflon, polypropylene (PP) or polyethylene (PE). It is for preventing artificial contamination that may be generated due to its material in measuring trace metal elements contained in the sediment. In particular, the polypropylene (PP) or the polyethylene (PE) may remove the trace metal elements attached in a surface by nitric acid.

An additional insert member 300 having the same shape of a cross section as that of the agitation preventing walls 100a, 100b and 100c to be able to be inserted into a section formed between one agitation preventing wall 100a and any other agitation preventing wall 100b is further included. The insert member 300 may have a stable material that has a superior formability, is washed by acid and does not contaminate the sediment. The material is preferably Styrofoam. Generally, Styrofoam may be formed to have diverse thicknesses and may be easily processed to have desired formats by users. Since Styrofoam may be washed with hydrochloric acid or nitric acid, artificial contamination to be generated in using the insert member is prevented.

member 300 is Styrofoam. Generally, Styrofoam may be formed to have diverse thicknesses and may be easily processed to have desired formats by users. Since Styrofoam may be washed with hydrochloric acid or nitric acid, artificial contamination to be generated in using the insert member is prevented.

The insert member 300 is required for clear division when the core sample 400 of a specific section arranged by the agitation preventing walls 100a, 100b and 100c is exhausted. A thickness of the insert member 300 plays a role of preventing bending toward the specific section generated by the core sample, in which the agitation preventing wall is exhausted, in consideration of the intervals between the agitation preventing walls.

It is preferred that the thickness of the agitation preventing walls 100a, 100b and 100c is as thin as possible and loss of the sample is minimized by maintaining the minimum hardness.

Regarding the sub-sampler according to the present invention, it is shown in the drawings that the cross section of the agitation preventing walls 100a, 100b and 100c has a fan shape but the present invention is not limited thereto. The agitation preventing walls 100a, 100b and 100c may have diverse shapes considering the shape of the cross section of the liner.

The present invention prevents that sediment is agitated with neighboring sediment in taking the sub-sample by separating the sediment at a regular interval by inserting the sub-sampler into the liner when the sub-sample is taken. In particular, the present invention solves the problem that the core sample having the high percentage of water content is agitated by collapse of sediment around the taken sub-sample while the sub-sample is taken. Accordingly, it is possible to accurately analyze continuous sediment and improve reliability.

Also, although the sediment around the sub-sample is not collapsed, it is possible to overcome the limitation that rest samples are agitated by efficiently fill in a specific area where the sample is taken.

The terms and words used in the present specification and claims should not be construed to be limited to the common or dictionary meaning, because an inventor defines the concept of the terms appropriately to describe his/her invention as best he/she can. Therefore, they should be construed as a meaning and concept fit to the technological concept and scope of the present invention.

What is claimed is:

1. A sub-sampler for assisting in taking of a sub-sample from a core sample by using a liner of a corer, comprising:
agitation preventing walls 100a, 100b and 100c including a top surface 10 having a predetermined length, a side surface 20 extended to be bent in a downward direction from one end of the top surface 10, and a contact surface 30 extended such that one end of the side surface meets the other end of the top surface 10; and
a cut piece 200 that allows an arrangement gap between one agitation preventing wall 100a and any other agitation preventing wall 100b to be regular and that is connected to the side surface 20 in order to close one side surface of the arranged agitation preventing walls 100a, 100b and 100c.

2. The sub-sampler of claim 1, wherein a curvature of the contact surface 30 of the agitation preventing walls 100a, 100b and 100c is preferably the same as that of the liner such that when the liner is cut in half in a longitudinal direction on the basis of an end portion of the liner, an inner circumferential surface of one side of the cut liner fits into the contact surface 30.

3. The sub-sampler of claim 1, wherein one agitation preventing wall 100a and another agitation preventing wall 100a are arranged in parallel and a gap between the agitation preventing walls 100a is 0.5 to 1 cm.

4. The sub-sampler of claim 3, wherein a material of the agitation preventing walls 100a, 100b and 100c and the cut piece 200 is Teflon, polypropylene (PP) or polyethylene (PE).

5. The sub-sampler of claim 4, further comprising:
an additional insert member 300 having the same shape of a cross section as that of the agitation preventing walls 100a, 100b and 100c to be able to be inserted into a section formed between one agitation preventing wall 100a and one agitation preventing wall 100b.

6. The sub-sampler of claim 5, wherein a material of the insert member 300 is Styrofoam.
